(19) United States
(12) Patent Application Publication
(10) Pub. No.: US 2026/0361803 A1
(43) Pub. Date: Nov. 12, 2026

(54) SYSTEM AND METHOD FOR SEAMLESS USER ENGAGEMENT

(71) Applicant: Differential Dev Shop, LLC, Cincinnati, OH (US)

(72) Inventors: David Woody, Cincinnati, OH (US); Sean McCosh, Cincinnati, OH (US)

(21) Appl. No.: 19/548,527

(22) Filed: Feb. 24, 2026

Related U.S. Application Data
(60) Provisional application No. 63/763,073, filed on Feb. 25, 2025.

(51) Int. Cl. H04L 67/63; G06Q 20/36

(52) U.S. Cl. CPC H04L 67/63; G06Q 20/36

(57) ABSTRACT

Systems and methods enable user engagement in an environment via interaction-enabled assets. A machine-readable trigger associated with an asset, including at least one of an NFC tag, a QR code, or a Bluetooth beacon, provides a network address to a mobile device upon interaction. A backend server receives a request based on the network address and routes the request to determine an engagement experience for the asset. The server causes the mobile device to present the engagement experience as a lightweight application experience or a web experience without requiring installation of a full native application. User interaction with the engagement experience generates interaction data that is received by the backend server. The backend server integrates at least a portion of the interaction data into an environment management system, including updating an existing profile or creating a new profile. Optionally, the server stores engagement analytics and maps interaction data fields for integration.

### CROSS-REFERENCE TO RELATED APPLICATION

The present application claims priority to and the benefit of U.S. Provisional Application No. 63/763,073, filed Feb. 25, 2025, the contents of which are incorporated herein by reference and made a part hereof.

### BACKGROUND OF THE INVENTION

The present invention generally relates to seamless engagement between a user, a mobile device, and an environment. More particularly the invention relates to a system and method for utilizing a software or hardware trigger in a particular environment to engage a user to perform a frictionless task as well as integrating data associated with that task into an environment management system.

In one example, in the field of church management and attendee engagement, churches face significant challenges in facilitating efficient, low-friction interactions with their congregations. Traditional methods, such as passing offering plates for donations, distributing paper forms for event registration, or manually collecting feedback, are time-consuming, disrupt the flow of services, and are prone to errors. Similarly, existing digital solutions often require attendees to download and install full mobile applications or input too much information, which can deter participation, especially among sporadic attendees or visitors who may not wish to commit to a full app or enter personal information. Furthermore, integrating data from these interactions into church management systems typically involves manual entry by staff or volunteers, leading to delays and inaccuracies.

As used herein, “reduced friction” and “seamless engagement” refer to objective system behavior in which the user device is caused to present an engagement experience as a lightweight experience launch or web experience in response to interaction with a machine-readable trigger, without requiring installation of a full native application, and in which interaction data is automatically captured and integrated into the environment management system without manual re-entry by an operator.

This invention addresses these problems by introducing a novel process that leverages hardware and software solutions placed in an environment to trigger mobile app technologies.

### SUMMARY OF THE INVENTION

The disclosed technology provides a system and method for seamless user engagement within an environment by using interaction-enabled assets (e.g., physical fixtures or signage) that incorporate machine-readable triggers such as NFC tags, QR codes, and optionally Bluetooth/BLE beacons. When a user interacts with a trigger using a mobile device, the trigger provides a network address (e.g., a URL) that is routed by a backend server to launch a corresponding digital engagement experience on the device, such as a lightweight application experience (including iOS App Clips or Android Instant Apps) or a mobile web experience, without requiring installation of a full native application.

In some embodiments, an administrative interface enables an operator to configure and manage the interaction-enabled assets and to assign actions/content to specific triggers, including customizing the experiences delivered upon a tap/scan. The backend server receives interaction data generated by the user (e.g., registration, survey response, content access, or other action data) and integrates that data into an environment management system (e.g., a CRM or people management database), including updating existing records or creating new records as needed.

The accompanying figures illustrate exemplary implementations. FIGS. 1A-1B depict an example system architecture showing interaction-enabled assets scanned by mobile devices, routing by the backend server, delivery of engagement experiences, administrative configuration, analytics, and integrations with management systems. FIG. 2 illustrates an example tap/scan-to-launch workflow from trigger interaction through backend routing to experience delivery and completion. FIG. 3 illustrates an example integration flow in which user action data is processed and merged into management-system records, including a “person/profile” association and action/transaction record updates.

In various embodiments, the engagement experience supports a range of environment-specific actions, including event registration, volunteer sign-up, feedback surveys, access to multimedia resources, prayer requests, and language translation. In optional payment-related embodiments, the engagement experience can support digital wallet-based payments and integration of resulting confirmation/record data into the management system, while maintaining the overall low-friction workflow initiated by the tap/scan trigger.

Additional embodiments, variations, and configurations are illustrated and described in the accompanying figures.

### BRIEF DESCRIPTION OF THE DRAWINGS

In the accompanying figures, like elements are identified by like reference numerals among the several preferred embodiments of the present invention.

FIGS. 1A and 1B illustrate an example overall system architecture, showing NFC tags, QR codes, mobile devices, backend server, and environment management system.

FIG. 2 illustrates an example flow chart of the process from NFC tap/QR scan to experience launch.

FIG. 3 illustrates an example data flow diagram from user action (e.g., donation) to integration with the church management system.

Other aspects and advantages of the present invention will become apparent upon consideration of the following detailed description, wherein similar structures have similar reference numerals.

### DETAILED DESCRIPTION OF THE PREFERRED EMBODIMENTS

The foregoing and other features and advantages of the invention will become more apparent from the following detailed description of an exemplary embodiment, read in conjunction with the accompanying drawings. The detailed description and drawings are merely illustrative of the invention rather than limiting, the scope of the invention being defined by the appended claims and equivalents thereof.

The present disclosure relates to seamless engagement between a user 110, a user device 110, and an engagement system 100 for seamless engagement between a user device 110 and an environment. In various embodiments, interaction-enabled assets 120 are placed within the environment and are configured to trigger an engagement experience 130 on the user device. The engagement experience enables a user to perform an action with reduced friction and generates interaction data that is integrated into an environment management system 140. From a high level, the invention provides a trigger-to-experience orchestration layer in which interaction-enabled assets 120 deployed in an environment resolve to tenant-specific engagement experiences 130 using a backend routing and mapping configuration (e.g., through an administrative interface 170) such that (i) a user device 110 can launch an appropriate lightweight application experience 210 or web experience without installing a full native application, and (ii) interaction outcomes are automatically normalized and integrated into the environment management system 140 as profile and action history entries 230 that support follow-on actions and reporting.

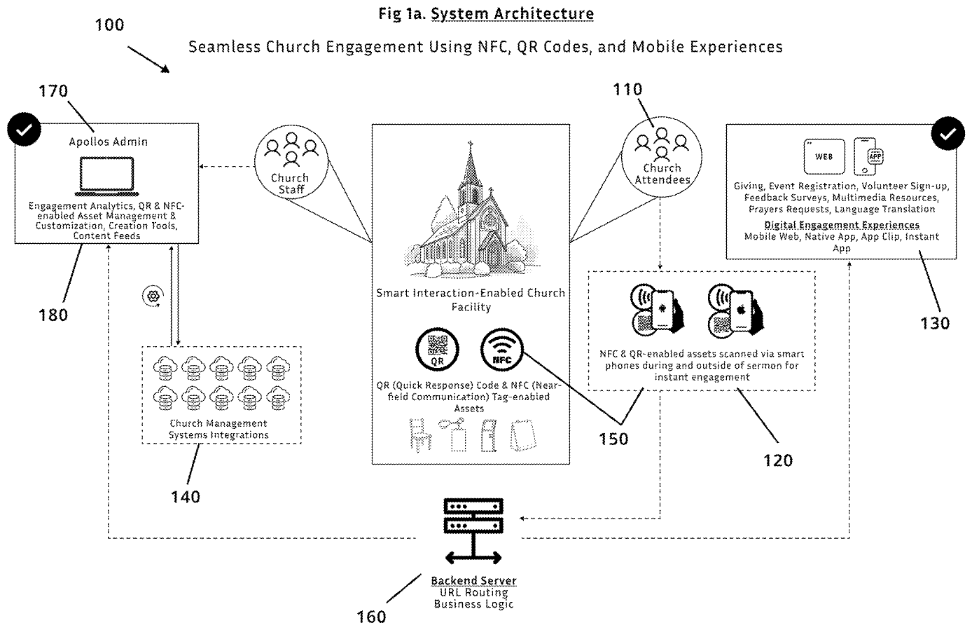

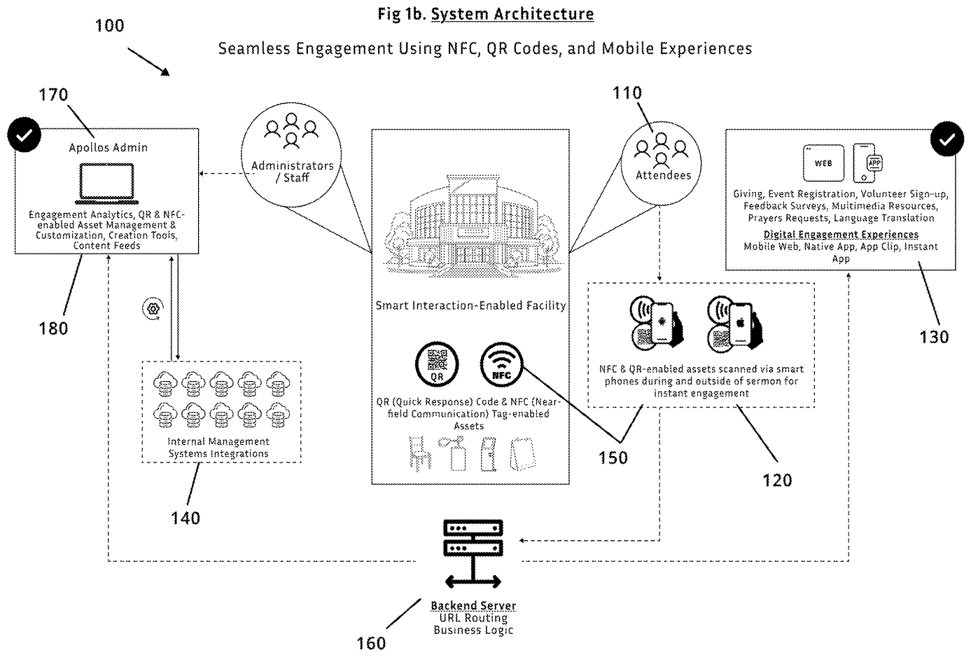

FIG. 1A-1B illustrate an example engagement system 100 for seamless engagement between a user device 110 and an environment. The system 100 includes interaction-enabled assets 120 positioned in the environment, where each asset 120 includes or is associated with a machine-readable trigger 150 (e.g., an NFC tag, a QR code, and/or a Bluetooth/BLE beacon) readable by the user device 110. In response to interaction with the trigger 150, a backend server 160 receives a request to deliver an engagement experience 130 (a lightweight application experience and/or web experience) to the user device 110, and to integrate resulting interaction data into an environment management system 140 (e.g., a CRM or people management database).

In the example architecture of FIG. 1A-1B, an administrative interface 170 is provided to enable an operator to configure the system 100, including associating engagement experiences 130 with respective assets 120, customizing content, and mapping data fields for integration into the environment management system 140. The backend server 160 may generate or store engagement analytics 180, such as usage and completion metrics associated with interactions with assets 120 and engagement experiences 130.

In some aspects, interaction-enabled assets 120 include physical fixtures, signage, seatbacks, kiosks, or other items positioned within the environment. Each asset 120 includes, or is associated with, a machine-readable trigger 150 configured to be detected by the user device 110. When the user device 110 taps, scans, or otherwise interacts with the trigger 150, the user device 110 obtains a network address, such as a permanent URL or asset link 190, associated with the asset 120.

Further in some aspects, the permanent URL or asset link 190 follows a structured format in which the URL encodes an organization identifier and an asset identifier and/or action identifier. By way of example, a URL may be formatted as https://cdn.apollos.app/app-link/:church/tag, where: church represents a unique organization identifier (e.g., a church identifier in a church embodiment) and/tag represents a specific action or tag identifier (e.g., an action such as/giving). This URL structure is scalable and flexible, enabling organization-specific customization of the engagement experience 130 while allowing the backend server 160 to determine the organization and action and to route the request accordingly using routing and business logic 200.

In some embodiments, an NFC-based machine-readable trigger 150 comprises a passive NFC tag that is provisioned with the permanent URL or asset link 190 using NDEF formatting. In one example implementation, NFC tags may be procured by a service provider and branded with organization-specific graphics, and each NFC tag may be programmed with a custom URL corresponding to the organization and the associated asset/action prior to deployment within the environment. After provisioning, the NFC tags may be shipped or otherwise delivered to the operator for placement on, or in association with, the interaction-enabled assets 120 within the environment.

In other examples, a QR-based machine-readable trigger 150 is generated to encode a URL that corresponds to the same permanent URL or asset link 190 as an NFC tag, such that either a tap (NFC) or scan (QR) initiates the same routing behavior at the backend server 160. QR codes may be printed on materials such as flyers, seatbacks, signage, or other physical media for locations where NFC is impractical or where camera-based scanning is preferred.

In some embodiments, the permanent URL or asset link 190 encodes or otherwise indicates an organization identifier and an asset identifier and/or action identifier. The user device 110 transmits a request to the backend server 160 based on the asset link 190. The backend server 160 performs routing and business logic 200 to resolve the organization and the asset/action and to select an engagement experience 130 associated with the asset 120.

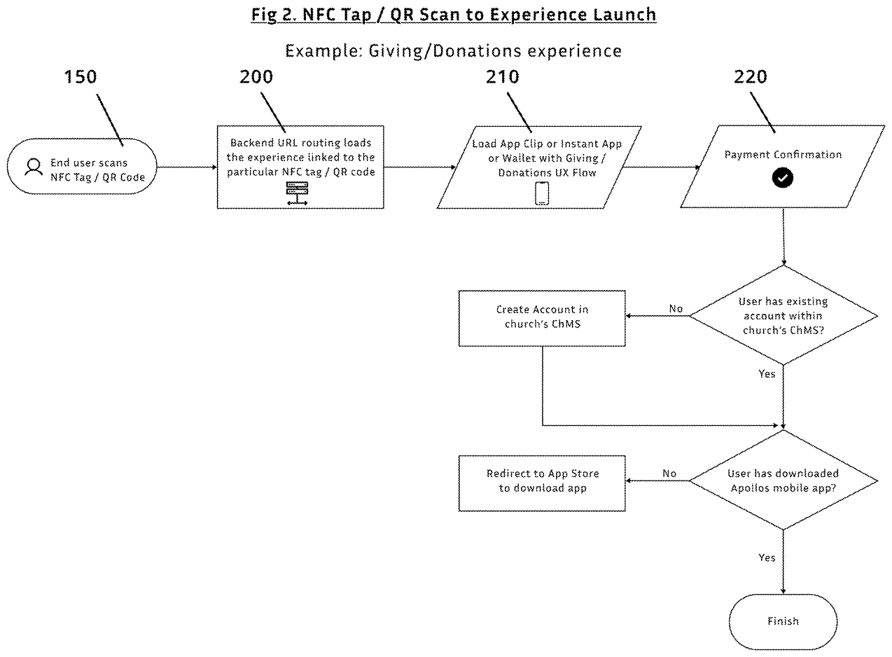

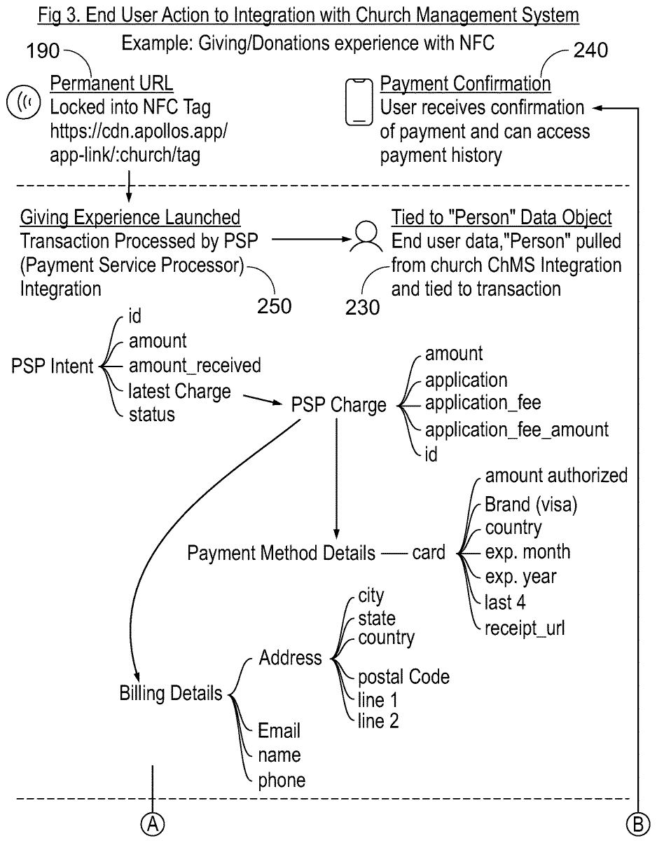

FIG. 2 illustrates an example flow from interaction with a trigger 150 to launching an engagement experience 130. In some embodiments, the backend server 160 causes the engagement experience 130 to be presented as a lightweight experience launch 210 or a web experience on the user device 110. The flow may result in a confirmation output 220 presented on the user device 110, such as a confirmation message or link.

In some aspects, the administrative interface 170 enables an operator to configure engagement experiences 130. Configuration may include assigning particular actions to particular assets 120, customizing content presented by an engagement experience 130, and defining mappings between fields produced by the engagement experience 130 and fields supported by the environment management system 140.

In response to user interaction, the engagement experience 130 generates interaction data. The backend server 160 receives the interaction data and integrates at least a portion of the interaction data into the environment management system 140. In some embodiments, integration includes updating an existing profile record or creating a new profile record when no matching record is found, and associating interaction data with a person/action record association 230 within the environment management system 140.

In some embodiments, integration with the environment management system 140 is performed using one or more application programming interfaces (APIs) and/or by direct database access, such that interaction data generated by the engagement experience 130 is appended to records maintained by the environment management system 140. In a church embodiment, the environment management system 140 may comprise a church management system or CRM (e.g., RockRMS, Ministry Platform, Fellowship One, Planning Center, or other people-data management systems), and the backend server 160 may push interaction data, such as survey responses, registration records, or donation details, into the corresponding data model via the integration mechanism. In some embodiments, the administrative interface 170 supports mapping of data fields produced by the engagement experience 130 to fields supported by the environment management system 140 to enable automated record updates. While certain embodiments are described using a church environment for clarity, the environment may comprise, without limitation, a stadium or arena, a retail location, a conference or tradeshow venue, a transportation hub, a museum, a campus, or a hospitality venue, in which interaction-enabled assets 120 with triggers 150 are deployed to launch engagement experiences 130 and integrate interaction data into an environment management system 140.

In some embodiments, the backend server 160 attempts to associate interaction data with an existing profile record (e.g., a person/profile record) maintained by the environment management system 140 and, if the user is recognized, updates the existing record; otherwise, the backend server 160 creates a new profile record and associates the interaction data accordingly (e.g., via person/action record association 230). In payment embodiments, post-transaction data (e.g., donation amount and related transaction information) may be provided to the environment management system 140, supporting organizational tracking and reporting (including, in some embodiments, tax reporting and engagement analysis).

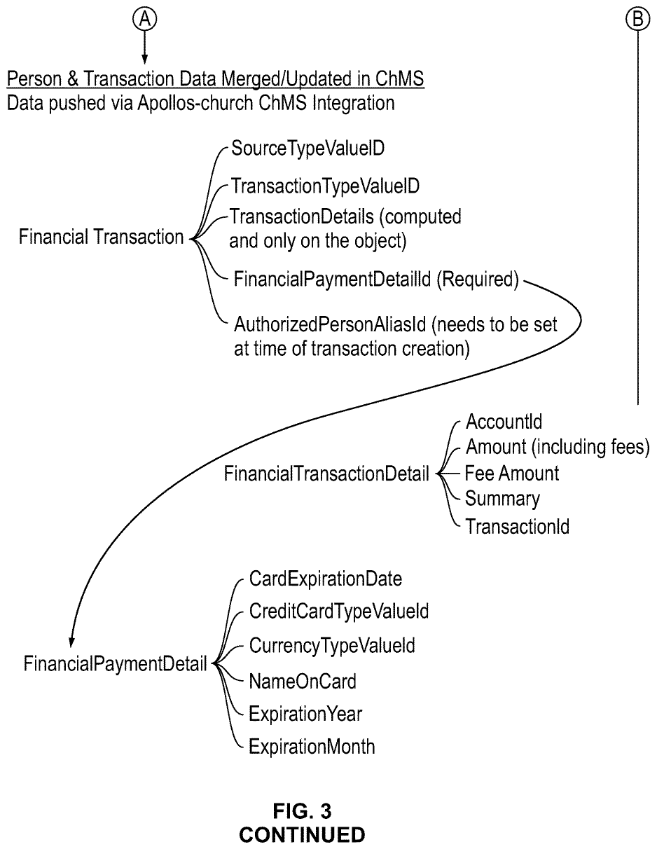

FIG. 3 illustrates an example in which a permanent URL or asset link 190 is used to initiate an action and a confirmation 240 may be provided. In optional payment embodiments, a payment service processor 250 processes payment data and returns payment confirmation data 240, and the backend server 160 integrates transaction data into the environment management system 140 and associates the transaction data with a profile record via the person/action record association 230.

In some aspects, the backend server 160 stores engagement analytics 180 associated with interactions with the interaction-enabled assets 120 and engagement experiences 130.

In addition to the embodiments described above, the engagement experience 130 may be configured to support a broader range of environment-specific actions initiated by interaction with a trigger 150 and routed by the backend server 160. By way of example, and without limitation, the engagement experience 130 may include food and beverage ordering and payment, event-related product ordering and payment, access to presentation notes or resources, real-time technology-enhanced note-taking experiences, feedback collection, prayer request submission, and workflows that connect users with ministries or other organizational subgroups, in addition to event registration, surveys/polls, volunteer sign-ups, multimedia content access, and language translation. In some embodiments, an operator uses the administrative interface 170 to assign such actions to particular assets 120 and to customize the content and user flow for each engagement experience 130, with resulting interaction data integrated into the environment management system 140.

In one embodiment, the engagement experience 130 comprises an event registration workflow. A user interacts with an interaction-enabled asset 120, the backend server 160 routes the request using routing and business logic 200 to an event registration experience, and user-submitted registration data is integrated into the environment management system 140.

In another embodiment, the engagement experience 130 comprises a volunteer sign-up workflow. A user provides sign-up information via the engagement experience 130, and the backend server 160 integrates the sign-up information into the environment management system 140.

In a further embodiment, the engagement experience 130 comprises a feedback survey. The engagement experience 130 presents survey questions, collects responses, and the backend server 160 integrates survey response data into the environment management system 140.

In one aspect, the engagement experience 130 provides access to multimedia resources associated with the environment. The backend server 160 delivers content links or resources responsive to interaction with an asset 120, and may record the access event as interaction data for integration into the environment management system 140.

In yet another aspect, the engagement experience 130 provides language translation options. The engagement experience 130 enables selection of a language and presents translated content or provides access to translation resources.

In one embodiment, the engagement experience 130 comprises a payment experience. The payment experience receives payment data and the backend server 160 processes a payment via the payment service processor 250. A payment confirmation 240 may be provided via a link associated with an interaction-enabled asset 120, and transaction data may be integrated into the environment management system 140 and associated with a profile record via the person/action record association 230.

In some embodiments, in addition to updating an existing profile record or creating a new profile record in the environment management system 140, the backend server 160 stores, in association with the profile record, interaction history entries corresponding to a plurality of engagement experiences 130 initiated via the interaction-enabled assets 120. Such interaction history entries may include entries corresponding to on-site engagements initiated via the interaction-enabled assets 120 (e.g., engagements occurring at the environment and/or during and outside of scheduled events) as well as entries corresponding to engagements initiated remote from the environment over time (e.g., via a network interface of the platform). In some embodiments, the backend server 160 uses the interaction history associated with the profile record to determine a personalized next action or engagement experience for the user and causes the user device 110 to present the personalized next action or engagement experience.

In further embodiments, the foregoing operations (including storing interaction history entries, updating or creating the profile record, and determining and presenting the personalized next action) are implemented by one or more processors of the backend server 160 executing instructions stored on a non-transitory computer-readable medium.

Those of ordinary skill in the art will understand and appreciate the aforementioned description of the invention has been made with reference to a certain exemplary embodiment of the invention, which describe a system and method of user frictionless engagement in an environment and a method of use. Those of skill in the art will understand that obvious variations in construction, material, dimensions or properties may be made without departing from the scope of the invention which is intended to be limited only by the claims appended hereto.

1. A system for enabling engagement in an environment, comprising:
a plurality of interaction-enabled assets located in the environment, each interaction-enabled asset including a machine-readable trigger that, when interacted with by a mobile device, provides a network address;
a backend server configured to receive a request based on the network address and to perform routing based on the network address to determine an engagement experience associated with a respective interaction-enabled asset;
wherein the backend server is configured to cause the mobile device to launch the engagement experience as a lightweight application experience or a web experience without requiring installation of a full native application;
wherein the backend server is configured to receive interaction data generated by user interaction with the engagement experience; and
wherein the backend server is configured to integrate at least a portion of the interaction data into an environment management system.

2. The system of claim 1, wherein the machine-readable trigger comprises at least one of: a near-field communication (NFC) tag, a quick response (QR) code, or a Bluetooth beacon.

3. The system of claim 1, wherein the network address comprises a URL including (i) an organization identifier and (ii) an asset identifier or action identifier, and wherein the routing selects the engagement experience based on at least the asset identifier or action identifier.

4. The system of claim 1, further comprising an administrative interface configured to: (i) assign a selected engagement experience to a respective interaction-enabled asset, (ii) customize content presented by the engagement experience, and (iii) map one or more fields of the interaction data to the environment management system.

5. The system of claim 1, wherein integrating the portion of the interaction data comprises updating an existing profile in the environment management system or creating a new profile in the environment management system.

6. The system of claim 1, wherein integrating comprises storing, in association with a profile record, interaction history entries corresponding to a plurality of engagement experiences initiated via the interaction-enabled assets.

7. The system of claim 6, wherein the backend server is configured to determine a personalized next action or engagement experience for the user based on interaction history associated with the profile record that includes (i) on-site engagements initiated via the interaction-enabled assets or (ii) off-site engagements initiated remote from the environment over time, and to cause the mobile device to present the personalized next action.

8. The system of claim 1, wherein the backend server stores engagement analytics associated with interactions with the interaction-enabled assets.

9. The system of claim 1, wherein the engagement experience comprises at least one of:
event registration, volunteer sign-up, feedback survey submission, access to multimedia resources, or language translation, a payment experience configured to receive payment data from the user.

10. The system of claim 9, wherein the payment experience supports a digital wallet payment, and wherein the backend server processes the payment via a payment service processor and generates a payment confirmation.

11. The system of claim 9, wherein integrating comprises integrating payment transaction data into the environment management system and associating the payment transaction data with a person profile record.

12. A method for enabling engagement in an environment, comprising:
providing an interaction-enabled asset in the environment including a trigger storing or encoding a network address;
receiving, at a backend server, a request derived from interaction by a mobile device with the trigger; routing the request based on the network address to select an engagement experience associated with the interaction-enabled asset;
causing the mobile device to present the engagement experience as a lightweight application experience or a web experience;
receiving interaction data generated by a user through the engagement experience; and integrating at least a portion of the interaction data into an environment management system.

13. The method of claim 12, wherein the trigger comprises at least one of: a near-field communication (NFC) tag, a quick response (QR) code, or a Bluetooth beacon.

14. The method of claim 12, wherein the network address comprises a URL including (i) an organization identifier and (ii) an asset identifier or action identifier, and wherein routing selects the engagement experience based on at least the asset identifier or action identifier.

15. The method of claim 12, further comprising, via an administrative interface: assigning a selected engagement experience to the interaction-enabled asset, customizing content presented by the engagement experience, and mapping one or more fields of the interaction data to the environment management system.

16. The method of claim 12, wherein integrating comprises storing, in association with a profile record, interaction history entries corresponding to a plurality of engagement experiences initiated via the interaction-enabled assets.

17. The method of claim 16, wherein the backend server is configured to determine a personalized next action or engagement experience for the user based on interaction history associated with the profile record that includes (i) on-site engagements initiated via the interaction-enabled assets or (ii) off-site engagements initiated remote from the environment over time, and to cause the mobile device to present the personalized next action.

18. The method of claim 12, wherein the engagement experience comprises a payment experience, and further comprising: receiving payment data, processing a payment via a payment service processor, and generating a payment confirmation.

19. The method of claim 18, wherein integrating comprises integrating payment transaction data into the environment management system and associating the payment transaction data with a person profile record.

20. A non-transitory computer-readable medium storing instructions that, when executed by one or more processors of a backend server, cause the backend server to:
receive a request derived from interaction of a mobile device with a trigger of an interaction-enabled asset located in an environment;
perform routing based on a network address to select an engagement experience associated with the interaction-enabled asset;
cause launch of the engagement experience on the mobile device as a lightweight application experience or a web experience without requiring installation of a full native application;
receive interaction data generated by user interaction with the engagement experience; and
integrate at least a portion of the interaction data into an environment management system by updating an existing profile in the environment management system or creating a new profile in the environment management system wherein the backend server is configured to determine a personalized next action or engagement experience for the user based on interaction history associated with the profile record that includes (i) on-site engagements initiated via the interaction-enabled assets or (ii) off-site engagements initiated remote from the environment over time, and to cause the mobile device to present the personalized next actions.
